(19) United States
(12) Patent Application Publication
(10) Pub. No.: US 2004/0012987 A1
(43) Pub. Date: Jan. 22, 2004

(54) Anomaly detection circuit of inverter and electronic apparatus comprising inverter incorporating the same

(75) Inventors: Seiji Hachisuka, Kawasaki (JP); Masaru Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/368,598

(22) Filed: Feb. 20, 2003

(30) Foreign Application Priority Data
Jul. 22, 2002 (JP) 2002-212666

(51) Int. Cl. H02M 7/44

(52) U.S. Cl. 363/95

(57) ABSTRACT

An anomaly detection circuit of an inverter detects behavioral anomaly such as disconnection discharge of a circuit wiring or discharge between high and low voltage parts with high accuracy and prevents continuation of behavioral anomaly of the device. The anomaly detection circuit of the inverter comprises a current change detector, a detection signal output part wherein the current change detector detects change in a circuit current flowing in circuit wirings of the inverter leading from the DC input to the load through the intermediary of magnetic flux change(Δ φ) which occurred to the circuit wiring while the detection signal output part outputs a detection signal (Vs) representing behavioral anomaly when the change in circuit current detected by the current change detecting part exceeds a predetermined level.

### BACKGROUND OF THE INVENTION

1. Field of the Invention

The invention relates to an anomaly detection circuit of an inverter for feeding AC output to various loads such as a fluorescent light tube for use as the backlight of a liquid crystal display, and to electronic apparatuses such as a display device, an information processing device, a lighting device, and so forth, comprising the inverter incorporating the anomaly detection circuit, and in particular, to an anomaly detection circuit for detecting behavioral anomaly of an inverter such as disconnection discharge of circuit wiring of the inverter, proximity discharge between high voltage and low voltage parts of the circuit wiring thereof, and so forth.

2. Description of the Related Art

With a liquid crystal display (LCD), a fluorescent light tube (FL tube) is used as a light source, and an inverter is used as a lighting device. The inverter adopts a constant current circuit for adjustment of luminance, and so forth, and the FL tube is driven by a constant current to be lit up with a low current of about several mA at a high voltage, for example, in the order of 1.5 kV. A current route from the inverter to the FL tube corresponds to a segment of wiring, leading from a winding of an inverter transformer, on the high voltage side thereof, to the FL tube, and is susceptible to deformation under external pressure because it is long and thin in size since it passes by way of a multitude of members such as windings of the inverter transformer, a conductor pattern on a printed wiring board, connectors, wiring, etc. With a cellular phone, and a notebook-size PC, an installation space for the lighting device of the FL tube is particularly narrow, so that thin wiring leading from the inverter to the FL tube is susceptible to an effect of external pressure.

In case that a break occurs to the above-described current route of the inverter, flow of current is cut off, however, there arises a risk of the current route being maintained because the constant current at the high voltage flows in the current route of the FL tube, and a rise in voltage occurs at the time of the break, thereby resulting in continuation of discharge at a spot of the break. When the current route is maintained, current flows in the tube, so that the FL tube remains lit up. As a result, discovery of behavioral anomaly is delayed, and continuation of such an anomalous state is not preferable.

The invention relates to a technology in an inverter for feeding AC output to various loads such as a FL tube for use as a back light of a liquid crystal device, and so forth, to detect anomaly such as disconnection discharge occurring to circuit wiring and dielectric breakdown discharge between high voltage and low voltage parts, thereby avoiding the continuation of anomaly and displaying such anomaly.

There is a technology of detecting such a behavioral anomaly of an inverter, and avoiding continuation of such behavioral anomaly which is disclosed, for example, JP-A 6-140173 entitled “protection device for an discharge lamp lighting system”, JP-A 11-121190 entitled “discharge lamp lighting device”, and so forth.

According to JP-A 6-140173 entitled “protection device for an discharge lamp lighting system”, even if an discharge lamp is lit out at the time of anomaly, inconvenience to maintain the operation of a transistor inverter is avoided wherein an output of the inverter is taken out to monitor an oscillation condition by a monitor circuit, and anomaly occurring at the oscillation condition due to a short circuit inside the discharge lamp and so forth is detected by a monitoring pulse voltage so as to stop the operation of the inverter by stopping the feed of a DC voltage, and light out the discharge lamp. However, such a protection device is complex in configuration because it requires the monitor circuit for taking out the output of the inverter and monitoring thereof, a microcomputer for determining whether the monitoring pulse voltage is normal or anomalous, and so forth, and also since the output of the inverter is taken out to an outside, the inverter side is forced to take measures to cope with the change in an operating condition.

Further, according to JP 11-121190 entitled “discharge lamp lighting device”, noting that a high frequency voltage value is lowered when the high frequency voltage to be fed to an discharge lamp is discharged between a ground and a low voltage part, the high frequency voltage is detected by a high frequency voltage detection resistor connected to the discharge lamp, and the high frequency voltage is rectified to be converted into a DC voltage, and when a level of the DC voltage is in anomalous level, the discharge lamp lighting device is stopped in operation. However, the discharge lamp lighting device requires the high frequency voltage detection resistor directly connected to the discharge lamp, and also the difference in voltage at the time of normal and that at the time of anomaly (at the time of discharge) is determined by a voltage dividing ratio of a resistance voltage divider circuit configured by the high frequency voltage detection resistor and a threshold level of a switching transistor, and so forth, and hence the accuracy of determination of whether it is normal or anomalous is low, and also there is a risk of stoppage of operation by a level change at the time of normal. Even with the discharge lamp lighting device, since high frequency voltage detection resistor is connected to the high voltage part side to detect a high frequency voltage, special measures for changing a circuit condition and taking out the detection voltage are required.

Meanwhile, if there occurs discharge at a spot of the break of circuit wiring and between high voltage and low voltage parts, an electric change inside the inverter can be checked. However, when discharge occurs to a disconnection spot, a voltage value or current value representing discharge is increased inside the inverter, but the amount of change is small, and hence even if the detection voltage is simply compared with a reference voltage, when the difference in level therebetween at the time of anomaly and normal is small, an erroneous operation occurs frequently, and hence it is not practical. Accordingly, the detection of disconnection discharge or dielectric breakdown discharge between high and low voltage parts requires the combination of a differentiation circuit, a timer circuit and so forth for enhancing accuracy of detection, which however renders the circuit complex, which increases in manufacturing cost by the addition of circuit, resulting in lack of practice. In the case where the amount of change in waveforms is small at the time of normal behavior and at the time of discharge such as a very small discharge, sufficient accuracy of detection cannot be obtained even if a differentiation circuit is used, so that an erroneous operation occurs frequently and it lacks in reliability.

### SUMMARY OF THE INVENTION

The invention relates to an inverter for converting DC input to AC output so as to feed high voltage output to various loads such as an FL tube and so forth, and it is an object of the invention to detect behavioral anomaly such as a disconnection discharge of circuit wirings and discharge between high and low voltage part with high accuracy and with a simple configuration without using a differentiation circuit and so forth.

It is another object of the invention to prevent the continuation of behavioral anomaly.

Further, it is still another object of the invention to provide an electronic apparatus which is enhanced in reliability using the inverter.

More still further, other objects, characteristics and advantages of the invention are more clarified and can be sufficiently understood by the following explanation.

The anomaly detection circuit of the inverter of the invention and an electronic apparatus provided with an inverter incorporating the anomaly detection circuit are configured as follows.

The anomaly detection circuit of the inverter of the invention converts DC input into AC output so as to feed the AC output to a load (FL tube 4), and it comprises a current change detector (current change detector 32, current detection line 36) and detection signal output part (comparator 34), wherein the current change detector detects change in circuit current (i_{d}, i₁ or i₂) flowing in circuit wirings (14, 16, 52, 54, 70, 72) of the inverter leading from the DC input to the load through the intermediary of magnetic flux change (Δ φ) which occurred to the circuit wirings (14, 16, 52, 54, 70, 72), and the detection signal output part outputs a detection signal representing behavioral anomaly when the change in circuit current detected by the current change detector exceeds a predetermined level.

Described first of all is a principle of detecting behavioral anomaly, when a high voltage is fed from an inverter 2 to a load such as the FL tube 4, and so forth, anomaly such as discharge occurs to the output part of the inverter, the load side such as the FL tube 4 and so forth by some reason during the supply of high voltage, a circuit current is changed and the change in the circuit current causes a magnetic flux change Δ φ to occur to the circuit wirings 14, 16, 52, 54, 70, 72. Behavioral anomaly is, for example, disconnection discharge of a current route between the inverter and the load, discharge between the output voltage and low voltage parts of the inverter at the output side and so forth. With the inverter for feeding a high voltage output to the load, even if the current route is disconnected, discharge occurred to the disconnection spot to maintain the current route. In this case, there occurs the change in circuit current due to the continuation of discharge which causes magnetic flux change to occur to the circuit wiring. Further, when discharge occurs between the high voltage and low voltage parts at the output side of the inverter due to dielectric breakdown, the discharge causes the occurrence of an abrupt change in the circuit current, the change in the circuit current causes an abrupt magnetic flux change Δ φ to occur to the circuit wirings. When the magnetic flux change Δ φ acts on the detection line, a high voltage corresponding to the abrupt magnetic flux change Δ φ is generated in the detection line, wherein when the high voltage is taken out, the abrupt change in the circuit current can be easily detected, and whether it is behavioral anomaly or not can be easily determined based on the change in level. Accordingly, the circuit current can be indirectly monitored without touching the circuit current or voltage at the inverter side so that it is determined easily whether or not behavioral anomaly occurs to the inverter side, thereby obtaining a detection signal representing whether it is behavioral anomaly or not.

The anomaly detection circuit of the inverter is provided with a current change detector for detecting the change in the circuit current through the intermediary of a magnetic flux change, and the change in the circuit current and a predetermined level are compared with each other at the detection signal output part. The predetermined level is set to a level representing anomaly such as disconnection discharge of the circuit wiring, proximity discharge, dielectric breakdown discharge between the high voltage of low voltage parts of the circuit wiring and so forth. Accordingly, when the level of change in the circuit current exceeds the predetermined level, it is determined that the inverter is in behavioral anomaly and the detection signal output part outputs a detection signal representing behavioral anomaly.

When the anomaly detection circuit of the inverter is used, for example, as a backlight lighting device of a liquid crystal display, behavioral anomaly such as disconnection discharge of the circuit wiring, discharge between the high voltage and low voltage parts and so forth can be immediately detected, and the detection signal is used for protecting the inverter, a discharge tube such as an FL tube and so forth, thereby contributing to protection of the load such as the liquid crystal display and so forth from continuation of the behavioral anomaly of the inverter.

With the detection of the circuit current due to the magnetic flux change of the circuit wiring, since the change in circuit current can be indirectly detected without touching the inverter or load, a sharp change is not required for the circuit conditions of the inverter and so forth, and also a configuration of the current change detector side may correspond to a detection level, thereby enabling a design which is independently of a circuit configuration of the inverter side.

Accordingly, with the anomaly detection circuit of the inverter, behavioral anomaly such as disconnection discharge of the circuit wiring, the dielectric breakdown discharge and so forth can be detected without an erroneous operation with a simple configuration without requiring a complex circuit. Since the change in the circuit current can be detected through the intermediary of the magnetic flux change which occuring to the circuit wiring, behavioral anomaly can be detected with high accuracy from an anomalous waveform generated due to disconnection discharge of the circuit wiring, discharge between the high voltage and low voltage and so forth, and also the detection accuracy is high, and further the occurrence of behavioral anomaly can be immediately detected. Further, since the change in the circuit current can be indirectly detected without touching the circuit wiring, the current change detector, detection signal output part, and controller can be configured independently of the circuit configuration at the inverter side, without influencing on or changing the circuit configuration of the inverter or load and without requiring a specific part or circuit such as a complex differentiation circuit and so forth.

With the anomaly detection circuit of the inverter of the invention, if the current change detector also has the detection line (current detection line 36) arranged in the vicinity of the circuit wiring, the magnetic flux change of the circuit wiring is detected at the detection line, and the change in the circuit current is converted into a voltage and the voltage can be taken out.

With such a configuration, when the current flows to the circuit wiring, the magnetic flux and magnetic field generate around the center of the circuit wiring, wherein the magnetic flux is changed when the circuit current is changed. The magnetic flux change at the circuit wiring side acts on the detection line arranged in the vicinity of the circuit wiring, and a current corresponding to the magnetic flux change flows to the detection line. The current corresponds to the change in circuit current. Accordingly, a voltage corresponding to the change in circuit current is detected on the detection line, which is installed in a non-contact state relative to the circuit wiring, through the intermediary of the magnetic flux change. With such a configuration, the change in circuit current can be detected at the time of behavioral anomaly with high accuracy and without erroneous operation and without exerting an influence of the current detection on the inverter side so that the circuit configuration can be simplified without requiring a differentiation circuit and so forth, and also behavioral anomaly can be detected and determined with accuracy and certainty.

With a configuration set forth above, since the change in circuit current can be detected through the intermediary of magnetic flux change by disposing the detection line in proximity to the circuit wiring, the circuit configuration can be simplified because the detection line is merely arranged in the vicinity of the circuit wiring, and also since the detection line does not touch the circuit wiring, the change in circuit current with a level of a noise occurred due to disconnection discharge or dielectric breakdown can be detected with high accuracy without exerting an influence of the current detection on the circuit condition such as the inverter, load and so forth.

Further, with the anomaly detection circuit of the inverter, if the inverter is provided with a controller for stopping an inverter operation upon reception of the detection signal at the time of behavioral anomaly, the inverter operation can be stopped at the time of behavioral anomaly so that the inverter and the load for receiving the output of the inverter can be protected from continuation of behavioral anomaly.

Since the inverter is provided with such controller, the inverter operation can be stopped as soon as practicable at the time of behavioral anomaly, so that the inverter and the load thereof can be protected from continuation of behavioral anomaly, thereby enhancing safety and reliability of the inverter.

Further according to the display device of the invention, the anomaly detection circuit is installed together with the inverter, the display device receives the detection signal and displays behavioral anomaly or stop of inverter operation at the time of behavioral anomaly.

The display by the display device includes image display, sound of buzzer, other sound information notice and so forth. A display part of the display device receives a detection signal from the detection signal output part and effects the following operations at the time of behavioral anomaly.

(1) Display of behavioral anomaly such as disconnection discharge and discharge between high voltage and low voltage parts and so forth,

(2) Display of stop of the inverter operation,

(3) Display of either (1) or (2) or both (1) and (2).

It is possible to easily detect behavioral anomaly and the stop of the inverter operation from these displays so that necessary measures can be taken as soon as practicable.

With the configuration set forth above, behavioral anomaly or the stop of inverter operation is displayed at the time of behavioral anomaly, it is possible to easily detect behavioral anomaly or stop of the inverter operation from the display, thereby improving a protection function, and enhancing a reliability of the inverter operation.

Further, with the information processing device of the invention, anomaly can be detected using the anomaly detection circuit of the inverter, or the display of the anomalous state or display of the stop of the inverter operation can be displayed using the display device, or the information processing device is provided with the anomaly detection circuit of the inverter and the display device. That is, with the information processing device having such a configuration, a lighting device for driving an illumination load such as a discharge tube and so forth and a power supply system such as a power supply circuit and so forth can be configured using the inverter of the invention. Accordingly, if the information processing device is configured using such an anomaly detection circuit of the inverter, behavioral anomaly such as discharge and so forth can be immediately discovered, or continuation of behavioral anomaly can be avoided, and also the display of behavioral anomaly or the display of the stop of inverter operation can be effected, thereby facilitating the protection of the liquid crystal display. Still further, a reliability of a power supply device of various circuits can be enhanced, and the information processing device can be protected from continuation of behavioral anomaly of a power supply system, thereby contributing to a reliability of the operation.

With the configuration set forth above, anomaly such as disconnection discharge, dielectric breakdown and so forth can be detected using the anomaly detection circuit of the inverter and the display device set forth above, and the operation is stopped based on the detection of anomaly so that continuation of anomalous state can be avoided, and also confirmation of operation state can be easily effected on the basis of the display of anomaly or the stop of inverter operation, thereby enhancing a reliability of the information processing device.

### BRIEF DESCRIPTION OF THE DRAWINGS

FIG. 1 is a circuit diagram of an FL tube lighting device according to an embodiment of the invention;

FIG. 2 is a view showing an example of a current detector;

FIG. 3A is a view showing a normal waveform of operational waveforms of the FL tube lighting device at the time of normal behavior;

FIG. 3B is a view showing an anomalous waveform of the operational waveforms of the FL tube lighting device at the time of behavioral anomaly;

FIG. 4 is a circuit diagram of the FL tube lighting device at the time of anomaly;

FIG. 5A is a circuit diagram showing a case where a circuit wiring side of a primary winding of an inverter transformer is served as a current detection region, as another part of the current detection region;

FIG. 5B is a circuit diagram showing a case where a circuit wiring side of a secondary winding of an inverter transformer is served as a current detection region, as another part of the current detection region;

FIG. 6A is a perspective view of a current detector using a core according to another embodiment;

FIG. 6B is a perspective view of a current detector using a current detection line which is wound around a core according to another embodiment;

FIG. 6C is a view of a current detector using a current detection line which is wound around a circuit wiring according to another embodiment;

FIG. 7 is a circuit diagram of a display device according to the embodiment of the invention;

FIG. 8 is a flow chart showing behavioral anomaly verification processing;

FIG. 9A is a perspective view of a cellular phone using an inverter serving; as an information processing device according to the embodiment of the invention; and

FIG. 9B is a perspective view of a notebook-size PC using an inverter serving as an information processing device according to the embodiment of the invention.

### DESCRIPTION OF THE PREFERRED EMBODIMENTS

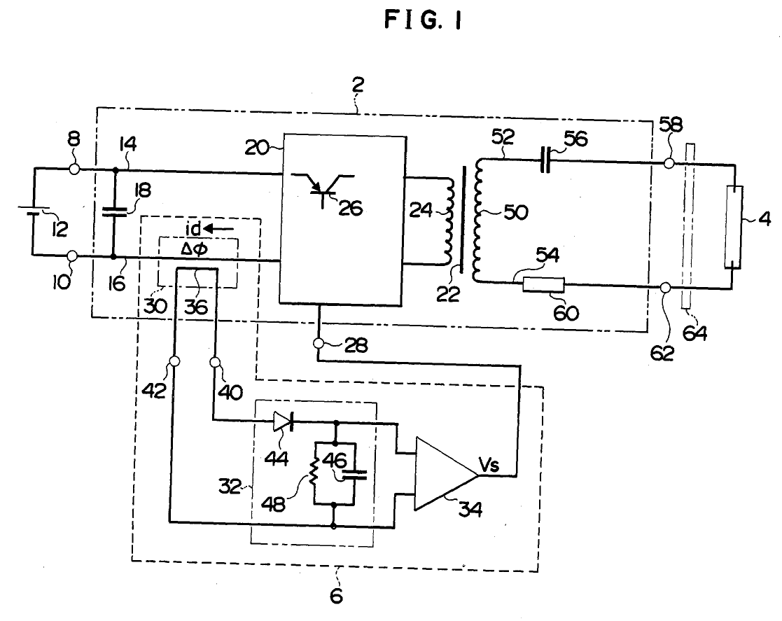

FIG. 1 shows an FL tube lighting device serving as an anomaly detection circuit of an inverter according to an embodiment of the invention. The FL tube lighting device constitutes an FL tube lighting device used as a backlight of a liquid crystal display (LCD).

The FL tube lighting device is provided with an inverter 2 for converting DC input into AC output, an FL tube 4 serving as a load to which the AC output is fed, and an anomaly detection circuit 6 connected to the inverter 2 for detecting disconnection discharge and dielectric breakdown discharge occurring to a circuit wiring.

The inverter 2 has DC input terminals 8, 10 for receiving DC input and the DC input terminals 8, 10 are connected to a DC power supply 12 from which DC input to be converted into AC output is fed. The DC power supply 12 includes various DC power supplies such as a battery, an AC-DC converter, and so forth. Circuit wirings 14, 16 are connected to the DC input terminals 8, 10 so as to form a current route of a DC input current and an input smoothing capacitor 18 is connected to the circuit wirings 14, 16. The circuit wirings 14,16 are formed of, for example, a conductor pattern on a printed circuit board, and the input smoothing capacitor 18 constitutes a filter for removing fluctuation component of a voltage ripple and the like included in the DC input and smoothes out a fluctuating DC input so as to stabilize it. The DC input is fed to an inverter controller 20 through the DC input terminals 8, 10 and the circuit wirings 14, 16. The inverter controller 20 comprises, for example, not shown, push-pull inverter circuit part formed of multiple transistors serving as switching elements, a drive circuit part, a switching controller, and so forth, and it also constitutes an oscillation circuit including a primary winding 24 of an inverter transformer 22 and so on in a feedback circuit. The inverter controller 20 incorporates a switch 26 serving as means for switching supply of power to the circuit wiring 14. The switch 26 switches over supply of power from outside on the basis of a control input fed to a latch input terminal 28 serving as a control input part of the inverter controller 20. A known device such as a general-purpose control IC (TI, TL5001, and so forth) which is already available in a market can be used as the inverter controller 20, and hence a detailed circuit configuration is omitted.

With the inverter 2, the anomaly detection circuit 6 for detecting behavioral anomaly comprises a current detector 30 for detecting a circuit current, a current change detector 32 for detecting a circuit current change, and a comparator 34 serving as anomaly determining means for determining whether a change level of the detected circuit current is anomalous or not.

The current detector 30 is means of detecting change in circuit current from a circuit wiring 16, and so forth, of the inverter 2. With the present embodiment, the circuit wiring 16 side of the inverter 2, which is a lower potential side thereof, is set as a current detection region. Disposed inside the current detector 30 is a current detection line 36 serving as current change detection means for detecting change in circuit current through the intermediary of a magnetic flux change ΔΦ that occurs to the circuit wiring 16. In this case, DC input current i(d is a detection target in connection with the change in circuit current, to be detected. The current detection line 36 is arranged in the vicinity of the circuit wiring 16, and at such a spacing therefrom as allowing the magnetic flux change ΔΦ occurring thereto to be detected.

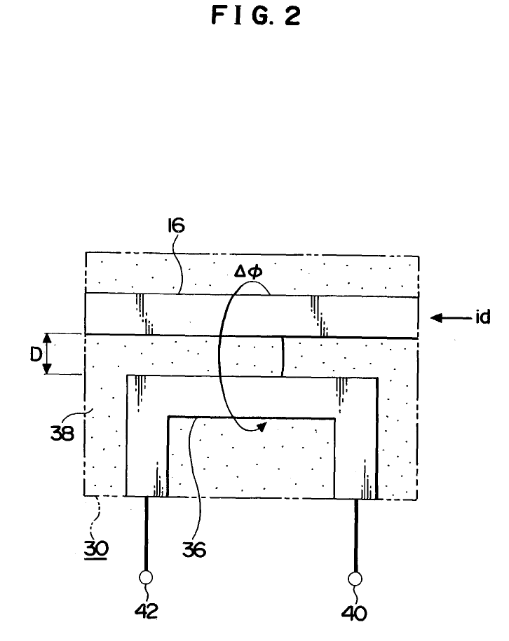

Further, as shown in FIG. 2 by way of example, with the current detector 30, the circuit wiring 16 and the current detection line 36 are formed of a conductor pattern, respectively, on a printed circuit board 38. That is, the current detection line 36 having a straight-line segment parallel with the circuit wiring 16 in a straight-line form is disposed, and the magnetic flux change ΔΦ occurring to the circuit wiring 16 due to a change in the DC input current i_{d} is caused to act on the current detection line 36. A predetermined insulating spacing D is set between the current detection line 36 and the circuit wiring 16. Sensitivity in detection of the magnetic flux change ΔΦ can be enhanced by rendering the insulating spacing D narrower.

The current detection line 36 is provided with detection terminals 40, 42, for taking out a voltage, generated through the agency of the magnetic flux change Aq), and a detection voltage obtained across the detection terminals 40, 42 is fed to a current change detector 32 for detecting change in circuit current. The current detector 30 according to the present embodiment is provided with a diode 44 serving as means for rectifying the detection voltage to be converted to a DC level, and the diode 44 is connected to the detection terminal 40 side of the current detector 30 while a capacitor 46 as a filter circuit together with a resistor 48 as means for adjusting a detection level are connected between the cathode side of the diode 44 and the detection terminal 42. For the diode 44, use is made of, for example, a Schottky diode having short reverse recovery time in order to cope with detection of current change due to disconnection discharge and so forth. The current change detector 32 of such a configuration as described is made up so as to serve as means for converting a change in the circuit current into a DC voltage, so that the DC voltage corresponding to the change in the circuit current is obtained at the capacitor 46 and the resistor 48, and a voltage level thereof represents the change in the circuit current, which is a change in the DC input current i_{d} in this case.

A detection signal from the current change detector 32 is fed to a comparator 34 serving as means for outputting detection signals. The comparator 34 is, as well as means for amplifying the detection signal, means for determining on the basis of a change level of the detected circuit current whether or not the behavioral anomaly exists, comparing the detection signal with a predetermined level displaying the behavioral anomaly. In this case, the predetermined level represents a reference level with which it is possible to determine that there exists behavioral anomaly such as, for example, disconnection discharge of the circuit wiring, proximity discharge (dielectric breakdown discharge) between high voltage and low voltage parts of the circuit wiring, and so forth, and the predetermined level may be set at any level such as a level at the time of normal behavior, a level slightly higher than the level at the time of normal behavior, and so forth, provided that determination on whether the behavior of the inverter is anomalous or normal can be made. Accordingly, the comparator 34 compares the detection signal with the predetermined level, outputting a detection signal Vs that turns to a low (L) level displaying normal when, for example, a detection voltage level is not higher than the predetermined level, and a detection signal Vs that turns to a high (H) level displaying anomaly when the detection voltage level exceeds the predetermined level. The detection signal Vs is fed to the latch input terminal 28 of the inverter controller 20, and is used for maintaining operation of the inverter controller 20 at the time of normal while stopping the operation of the inverter controller 20 at the time of anomaly. With the present embodiment, the switch 26 is caused to open at the time of anomaly by the detection signal fed to the latch input terminal 28, and supply of power to the inverter controller 20 is cut off, thereby controlling inverter operation so as to be in the off condition.

Further, circuit wirings 52, 54 are connected to a secondary winding 50 of an inverter transformer 22, thereby constituting a current route of output current. A ballast capacitor 56 is interposed within one of the circuit wirings 52, and is connected to a connecter 58 as an AC output terminal while a constant current detection resistor 60 is interposed within the other of the circuit wirings 54, and is connected to a connecter 62 as an AC output terminal. An FL tube 4, which is a load, is connected to the respective connecters 58, 62, constituting a backlight of an LCD 64. The ballast capacitor 56 is means for stabilizing tube current flowing in the FL tube 4, and the tube current detected by the constant current detection resistor 60 is fed to the inverter controller 20 side to be used for keeping the tube current constant. Accordingly, AC is generated by a switching action of the inverter controller 20, that is, a DC to AC conversion action thereof, and at the same time, high frequency output at high voltage provided to the secondary winding 50 of the inverter transformer 22 due to step-up in voltage of the inverter transformer 22 is fed to the FL tube 4 via the circuit wirings 52, 54, and the connecters 58, 62, respectively. The present embodiment shows a case where the FL tube 4, which is single in number, is connected to the secondary winding 50, which is single in number, however, a plurality of FL tubes may be installed, and in that case, the ballast capacitor 56 is installed for every FL tube.

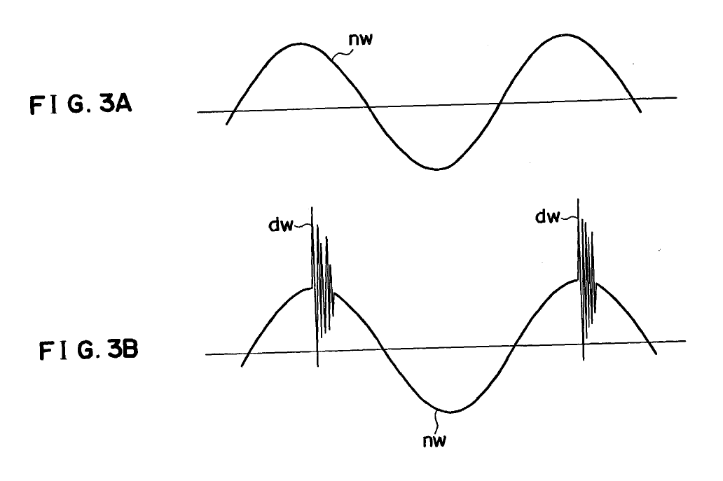

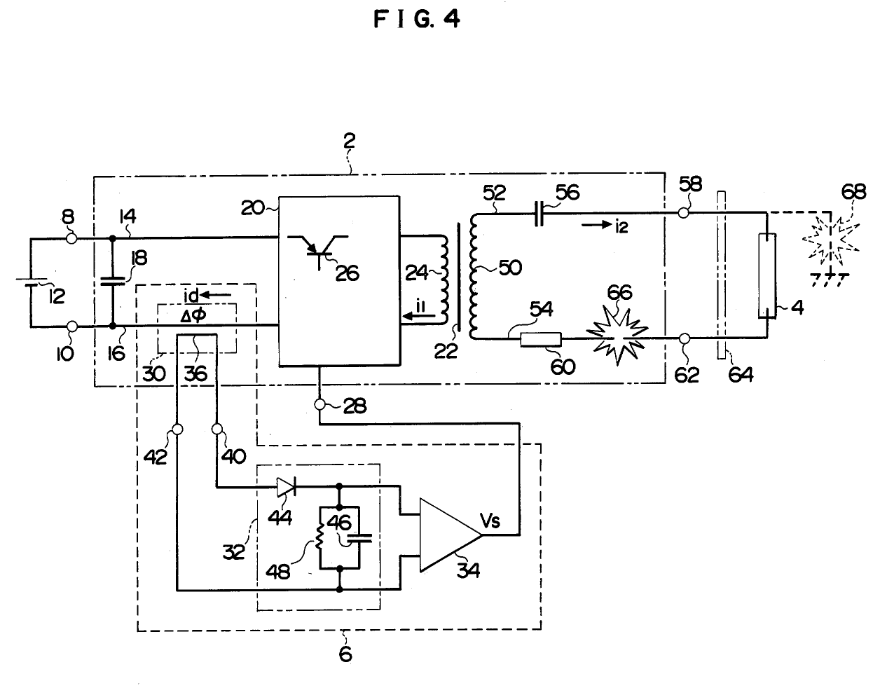

Upon driving the FL tube 4 with a constant current by use of the inverter 2 as described above, the FL tube 4 is lit up with a constant driving current. In the case of normal behavior, a behavior waveform of AC output will be a sinusoidal waveform nw as shown in FIG. 3A, however, if a break occurs to, for example, the circuit wiring 54 as shown in FIG. 4, discharge occurs to a spot 66 of the break, thereby maintaining a current route. A behavior waveform at the time of such an anomalous behavior as above will be an anomalous waveform composed of the sinusoidal waveform nw occurring at the time of the normal behavior with a discharge waveform dw superimposed thereon as shown in FIG. 3(B). The discharge waveform dw represents a noise (high frequency) undergoing an abrupt change from a gently-sloping fundamental waveform and having a high frequency component, however, such a waveform component does not cause an increase in amperage of the circuit current, but only causes an increase in change increment of the circuit current. Further, the discharge waveform dw occurs periodically in relation to a change in level of the sinusoidal waveform nw occurring at the time of the normal behavior. Such a phenomenon as described occurs to not only current waveform but also voltage waveform, however, it has been confirmed on the basis of experiments that change occurring to current waveform is greater than that for voltage waveform.

If a current route is maintained due to the discharge described, there occurs a rapid change to circuit current including output current i₂ of the inverter transformer 22, input current it of the inverter transformer 22, the DC input current i_{d}, drive current inside the inverter controller 20, and so forth, so that an intense magnetic flux change ΔΦ, displaying an abrupt change in circuit current, occurs around the circuit wirings 14, 16, constituting the current route. Hereupon, an abrupt magnetic flux change ΔΦ is detected by the current detection line 36, and a high voltage displaying a change in the circuit current is generated across both ends of the current detection line 36. Since the high voltage is rectified by the diode 44 and smoothed out by the capacitor 46, a DC voltage at a level displaying an abrupt change in current can be obtained at the time of discharge. The DC voltage is fed to the comparator 34, and is compared with the predetermined level, whereupon the comparator 34 obtains the detection signal Vs that displays whether the behavior is normal or anomalous.

When the detection signal Vs is fed to the latch input terminal 28 of the inverter controller 20 as an output of the stop of the operation, the switch 26 of the inverter controller 20 is turned into the off condition, thereby stopping inverter operation and canceling AC output, whereupon the FL tube 4 is turned into unlit condition, and at the same time, continuation of discharge is interrupted. As a result, the inverter 2 and the FL tube 4 are released from continuation of behavioral anomaly.

In case that a discharge 68, displayed by a broken line in FIG. 4, occurs due to dielectric breakdown and so forth, caused by proximity between a high voltage part on the AC output side and a low voltage part on a chassis, and so forth, a behavior waveform at that time will become an anomalous waveform composed of the sinusoidal waveform nw occurring at the time of the normal behavior with the discharge waveform dw superimposed thereon as shown in FIG. 3B as with the case of disconnection discharge.

In this case as well, an abrupt change in circuit current of the circuit wiring 16 causes a magnetic flux change ΔΦ to occur. The magnetic flux change ΔΦ is detected by the current detection line 36 of the current detector 30, and consequently, the comparator 34 obtains a detection signal Vs displaying behavioral anomaly. As a result, the inverter operation by the inverter controller 20 is stopped and AC output is cancelled, whereupon the FL tube 4 is turned into unlit condition, and at the same time, continuation of discharge is interrupted. Similarly, the inverter 2 and the FL tube 4 are released from continuation of behavioral anomaly.

The present embodiment can provide the following advantageous effects.

With the present embodiment, since the current detector 30 is installed on the input current side of the inverter controller 20, it is possible to detect through the intermediary of the magnetic flux change ΔΦ a rapid change in the input current, occurring due to behavioral anomaly caused by disconnection discharge, dielectric breakdown discharge, etc. in the current route on the output side, thereby causing a high voltage representing behavioral anomaly to occur across the detection terminals 40, 42. That is, the present embodiment is easier to cope with insulation as compared with the case of detecting behavioral anomaly on the high voltage side, and is also excellent in safety.

Further, with a very simple configuration wherein the current detection line 36 is disposed in parallel with the circuit wiring 16, it is possible to generate a voltage displaying a rapid change in the circuit current because a change in the circuit current is detected through the intermediary of the magnetic flux change ΔΦ, and in addition, to take out the change in the circuit current at high voltage. That is, sensitivity in detection of the change in circuit current is high and behavioral anomaly can be detected with high accuracy.

Further, although it is possible to detect behavioral anomaly in such as discharge and so forth from the change in voltage, the change in the circuit current is detected through the intermediary of the magnetic flux change Δ φ, so that the accuracy of detection is enhanced. That is, the change in waveform caused by discharge is large in the change in current waveform rather than that in voltage waveform, and the magnetic flux change Δ φ occurs due to the change in current, and hence the accuracy of detection of behavioral anomaly through the intermediary of the magnetic flux change Δ φ is enhanced.

When detecting the change in the circuit current through the intermediary of the magnetic flux change Δ φ, the magnetic flux change Δ φ can be detected with ease by a very simple configuration having the current detection line 36 which is arranged in parallel with the circuit wiring 16, and further the current detection line 36 can be installed without adding any change in the circuit condition at the inverter side, and also it is possible to configure the circuit arrangement of the current change detector 32 and the comparator 34 irrespective of the inverter side circuit in response to a high voltage generated at the detection terminals 40, 42, and hence the circuit configuration can be designed with ease.

Further, the current change detector 32 can obtain a DC voltage having a level necessary for determining whether a high voltage obtained at the detection terminals 40, 42 is normal behavior, or behavioral anomaly caused by discharge with a simple circuit configuration and processing such as rectification by the diode 44, the smoothing out by the capacitor 46, and so forth. That is, it is possible to generate a DC voltage in which normal behavior or behavioral anomaly caused by discharge clearly appears in the difference of level thereof. Accordingly, the comparator 34 can easily set a reference level for sharply differentiating between normal behavior and behavioral anomaly, and hence the accuracy of detection is high and behavioral anomaly can be detected without an erroneous operation.

When the detection signal Vs obtained by the comparator 34 is fed to the latch input terminal 28 of the inverter controller 20, the operation of the inverter controller 20 is stopped at the time of behavioral anomaly, thereby protecting the load such as the inverter 2, the FL tube 4 and so forth from continuation of behavioral anomaly.

Meanwhile, it is confirmed, according to an experiment, for the occurrence of detection voltage at the current detection line 36 which is irrespective of disconnection discharge or dielectric breakdown discharge, that the current detection line 36 can detect the increase in voltage caused by very small discharge by setting a circuit condition therein such that use is made of, for example, a Schottky diode having short reverse recovery time serving for the diode 44 of the current change detector 32, and the resistor 48 has a resistance value in the order of, for example, 0.1 MΩ to 5 MΩ, the capacitor 46 has an electrostatic capacitance in the order of 0.0015 μF to 0.1 μF, and so forth. As a result, it is possible to detect the behavioral anomaly such as a disconnection discharge or dielectric breakdown discharge, and also possible to prevent easily an erroneous operation caused by excessive current when power is turned on, and so forth. In this case, although concrete circuit conditions of the diode 44, the capacitor 46, the resistor 48 used in the experiment are exemplified, they can be arbitrarily set, and the invention is not limited to such circuit conditions.

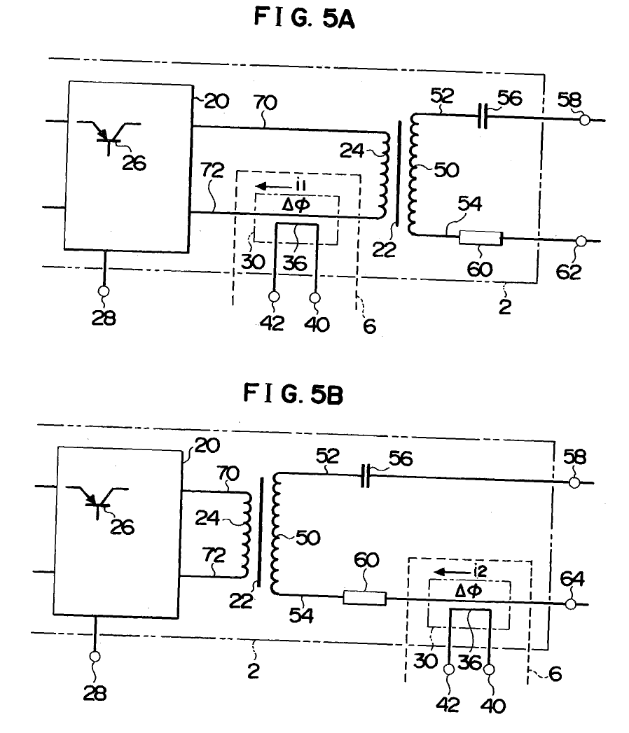

According to another embodiment of the invention, circuit wirings 70, 72 respectively connected to a primary wiring 24 of an inverter transformer 22 may be set as a current detection region for detecting behavioral anomaly as shown in FIG. 5A other than the circuit wiring 16 shown in FIG. 1, for example, a current detector 30 is installed in the circuit wiring 72, and a current detection line 36 may be arranged in the vicinity of the circuit wiring 72. Further, as shown in FIG. 5B, circuit wirings 52, 54 connected to a secondary wiring 50 of an inverter transformer 22 may be set as a current detector, and, for example, a current detector 30 is installed in the circuit wiring 54 and a current detection line 36 may be arranged in the vicinity of the circuit wiring 54. When the current detection line 36 is arranged in the vicinity of the circuit wiring 72, behavioral anomaly can be detected through the intermediary of the magnetic flux change Δ φ due to the change in a primary current i₁ which flows in the circuit wirings 70, 72 at the side of the primary winding 24 of the inverter transformer 22, thereby stopping the inverter operation.

Further, when the current detection line 36 is arranged in the vicinity of the circuit wiring 54, behavioral anomaly can be detected through the intermediary of the magnetic flux change Δ φ due to the change in an output current i₂ which flows in the circuit wiring 54, and the inverter operation can be stopped at the time of behavioral anomaly, and hence an inverter 2, an FL tube 4 and so forth can be protected from continuation of behavioral anomaly such as discharge and so forth. In this case, the change in a waveform is larger at the output side of the inverter transformer 22 compared with that at the input side thereof, and also the change value of the discharge waveform is remarkably increased, so that the accuracy of detection is enhanced.

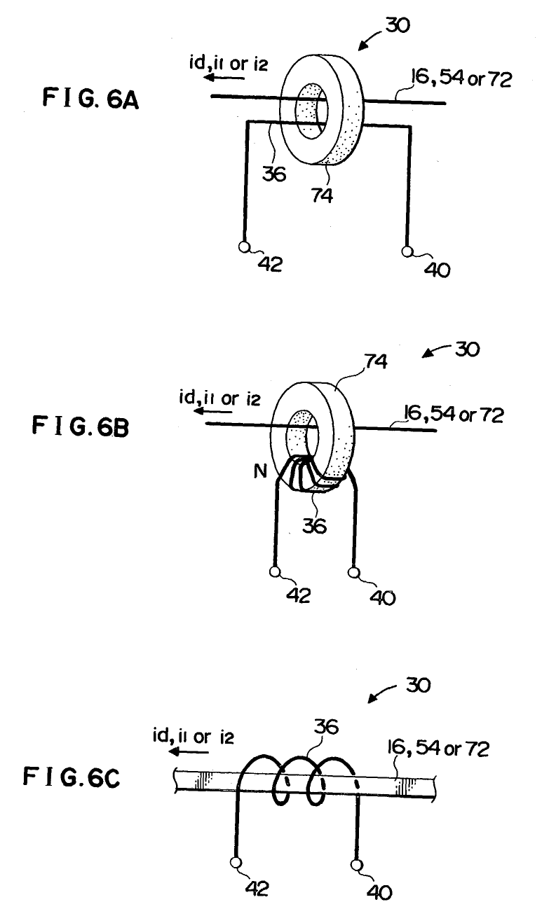

According to another embodiment of a current detector 30, for example, a ring-like core 74 is installed in a current detector 30, as shown in FIG. 6A, and circuit wirings 16, 54 or 72 and a current detection line 36 are allowed to pass in the core 74, so that with the core 74, a common magnetic path is formed in the circuit wirings 16, 54 or 72 and the current detection line 36 through which the magnetic flux change Δ φ passes. When using the core 74, the change in magnetic flux change Δ φ can be intensified by magnetic permeability μ of a magnetic material forming the core 74, and also a detection voltage of the detection terminals 40, 42 can be increased, thereby enhancing sensitivity in detection.

Further, for example, a current detection line 36 may be wound around a core 74 as shown in FIG. 6B. In this case, magnetic flux change Δ φ acting on the current detection line 36 is intensified by the number of turns N, and detection voltage generated in detection terminals 40, 42 is stepped up, thereby taking out higher detection voltage. In this case, circuit wirings 16, 54 or 72 may be wound around the core 74. Further, a cylindrical core may be used as the core 74, and even with the cylindrical core, a common magnetic path can be formed in the circuit wirings 16, 54 or 72 and a current detection line 36.

Still further, for example, a current detection line 36 is wound around the circuit wirings 16, 54 or 72 by several numbers of winding, as shown in FIG. 6C, so that the magnetic flux change Δ φ occurring to the circuit wirings 16, 54 or 72 may act on the current detection line 36. With such a configuration, detection voltage corresponding to the number of turns of the current detection line 36 can be taken out between the detection terminals 40, 42. With a configuration having no such a core 74, the number of parts is decreased, and hence the current detector 30 can be manufactured at low price. According to the anomaly detection circuit of an inverter having no the core 74, as shown in FIGS. 1, 4 and 5, the same effect as made here can be obtained.

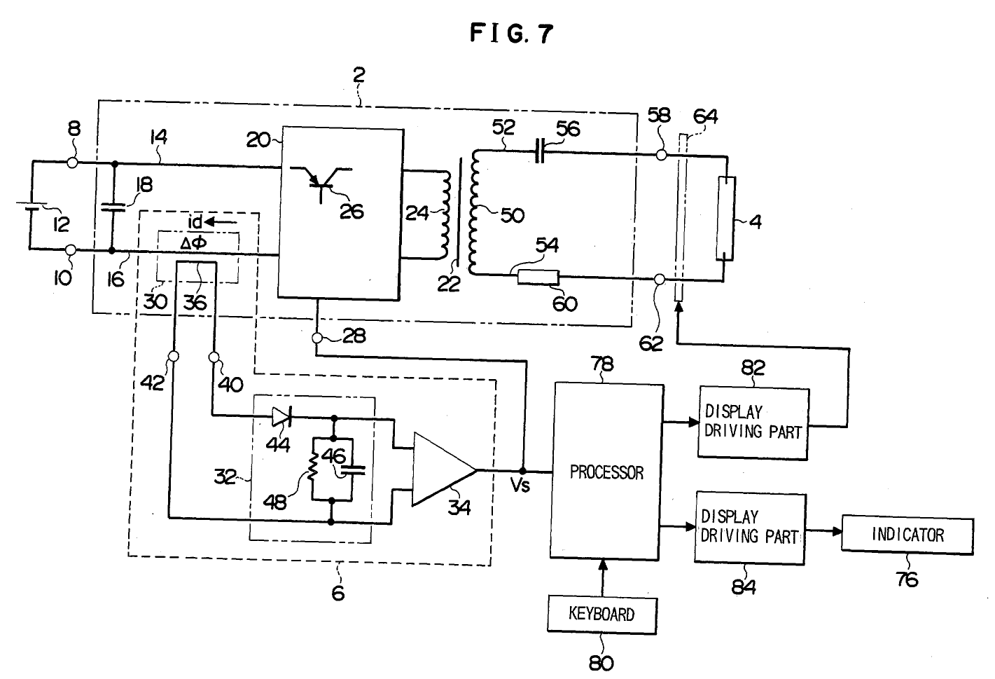

FIG. 7 shows a display device using the anomaly detection circuit of the inverter according to the invention. In the display device, the configurations, operations and effects of an inverter 2 and an anomaly detection circuit 6 are the same as those described with reference to FIGS. 1 to 6.

With the display device in FIG. 7, an LCD 64, and an indicator 76 serving as anomaly display device at the time of behavioral anomaly are installed, and a processor 78 is installed as display control means of these LCD 64 and indicator 76. The processor 78 is means for executing a control program for displaying behavioral anomaly stored in storage means, not shown, wherein a detection signal Vs obtained by a comparator 34 is fed to the processor 78 and a keyboard 80 is connected to the processor 78 through which instruction input for executing behavioral anomaly verification processing is inputted. An display driving part 82 is installed in the LCD 64 for executing predetermined display upon reception of a display control output from the processor 78 and an display driving part 84 is installed in the indicator 76.

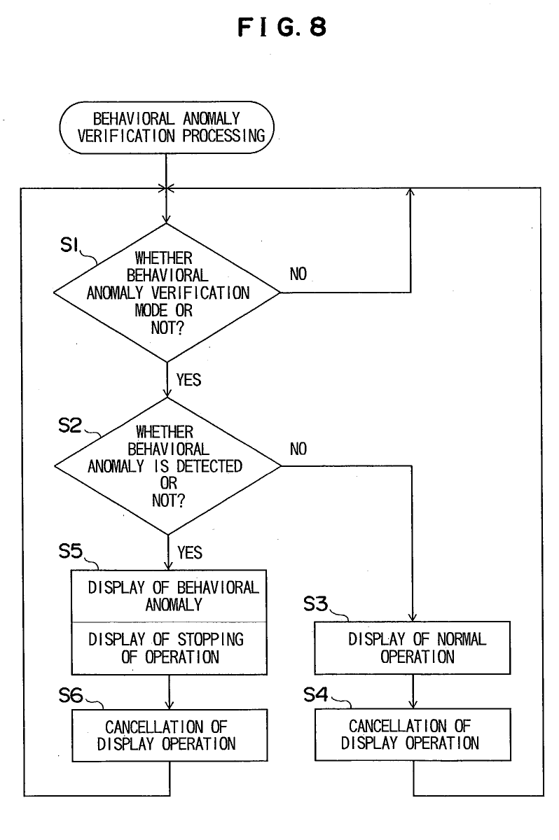

With such a configuration, the behavioral anomaly verification processing is executed as shown in, for example, a flow chart of FIG. 8. In step S1, it is determined whether or not the inverter is in behavioral anomaly verification mode. In this case, when a specific key of the keyboard 80 or an instruction assigned to multiple keys thereof are operated, behavioral anomaly verification mode is set. In this case, a behavioral anomaly verification mode is automatically set when power is turned on, anomaly of the inverter 2 may be confirmed. When the behavioral anomaly verification mode is established in step S1, a program goes to step S2 where the detection signal Vs from the comparator 34 is received so as to determine whether or not anomaly is detected.

At the time of normal, the program goes to step S3 where it is displayed that the LCD 64 or the indicator 76 has no behavioral anomaly, namely, it has a normal behavior. When a predetermined time elapses from the start of the display of the normal behavior or an administrator instructs an operation display cancel from the keyboard 80, the program goes to step S4 where display operation is cancelled, and the program returns to Step S1.

When behavioral anomaly is detected in step S2, the program goes to step S5 where behavioral anomaly is displayed on the LCD 64 or the indicator 76 and the stop of the inverter operation is displayed on the same. The administrator verifies these displays, and executes necessary processing. For example, when a predetermined time elapses from the start of the display of behavioral anomaly or the administrator instructs an operation display cancel from the keyboard 80, the program goes to step S6 where display cancel is effected, and the program turns to step S1. In this case, when behavioral anomaly is displayed, the display cancel may not be effected unless the administrator effects an improvement processing.

When the FL tube 4 serving as a light source of the LCD 64 is lit out, it is expected that content of the display of the LCD 64 is hardly verified, the indicator 76 is easily verified when displaying behavioral anomaly or the inverter 2 stops its operation. It is possible to use the LCD 64 for displaying the behavioral anomaly or the stop of the operation of the inverter 2. When the FL tube 4 is in unlit condition, and the display of such a condition can be verified, the indicator 76 is not always needed. If the display is effected using both the LCD 64 and the indicator 76, a reliability of the stop of operation and the display thereof can be enhanced.

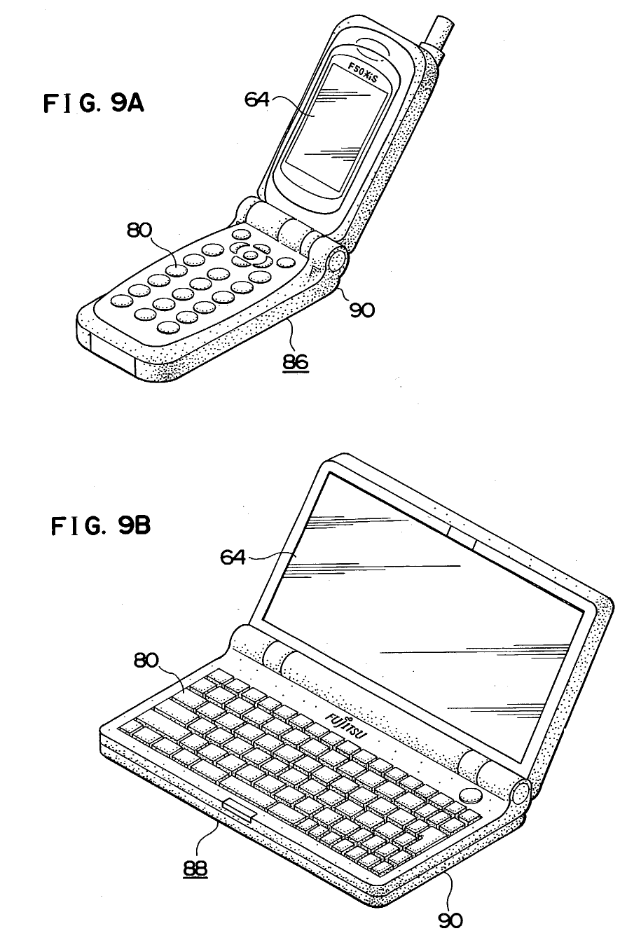

Next, FIGS. 9A and 9B show an information processing device according to the invention, and the information processing device is configured to use the anomaly detection circuit of the inverter or display device according to the invention, wherein FIG. 9A shows a cellular phone and FIG. 9B shows a notebook size PC.

With the information processing device shown in FIGS. 9A and 9B, an FL tube 4 is installed, as a backlight of an LCD 64 serving as a display device, in a housing 90 of a cellular phone 86 or a notebook size PC 88, and the inverter 2 shown in FIGS. 1 to 4 serving as a driving device or the anomaly detection circuit 6 of the inverter 2 according to the invention, and also a processor 78 serving as arithmetic control means, a keyboard 80, and so forth are incorporated therein. In this case, an indicator 76 serving as an display element is installed inside the housing 90 of the cellular phone 86 or the notebook size PC 88 for use in maintenance thereof, and it can be installed on an outer face of the housing 90.

With such a configuration, in the information processing device of the cellular phone 86, the notebook size PC 88 and so forth, behavioral anomaly such as a disconnection discharge, dielectric breakdown discharge of the circuit wirings 14, 16, circuit wirings 52, 54, circuit wirings 70, 72 of the inverter 2 respectively, and so forth can be monitored, and when the operation of the information processing device is stopped, the information processing device can be protected from continuation of behavioral anomaly. Further, since the behavioral anomaly or the stop of the operation is displayed on the LCD 64 or the indicator 76, the behavioral anomaly or the stop of operation can be quickly detected from the display thereof, thereby realizing a high reliable information processing device. Further, anomaly such as disconnection discharge, dielectric breakdown discharge of the circuit wirings 14, 16 and so forth of the inverter 2 can be easily determined from the content of the display, and hence necessary measures can be executed quickly, thereby providing a high reliable information processing device.

The invention includes other embodiments or electronic apparatus set forth hereunder in addition to the anomaly detection circuit of the inverter, display device or information processing device as set forth above.

a Although the comparator 34 for comparing a detection voltage with a predetermined level to output a detection signal is exemplified as the detection signal output means for outputting the detection signal representing behavioral anomaly when the change in a circuit current exceeds the predetermined level according to the embodiment of the invention, a switching transistor or a switching circuit which is rendered in a conductive or cut off state upon reception of the level of the detection signal may serve as the detection signal output means.

b It may be configured that after a detection voltage obtained at the detection terminals 40, 42 was rectified or a specific frequency component is taken out, it is converted into a digital signal, then the digital signal is fed to the processor 78 shown in FIG. 7, while the processor 78 is configured to serve as detection signal output means, whereby it is determined whether or not behavioral anomaly occurred in the inverter 2, and output of the determination is fed to the latch input terminal 28 of the inverter controller 20 as a control input, so that the operation of the inverter 2 may be stopped. In this case, behavioral anomaly such as discharge, and so forth and the condition thereof may be displayed on the LCD 64 or indicator 76 when stopping the operation.

c Although the circuit wiring 16 and current detection line 36 shown in FIG. 2 are formed by a conductor pattern on a printed wiring board, they may be formed of wire rods other than the conductor pattern. When the wire rods are used, the circuit wiring 16 and the current detection line 36 are bundled to cause the magnetic flux change Δ φ at the side of the circuit wiring 16 to act on the current detection line 36.

d The current change detection of the current change detector 32 may be effected by a detector circuit for detecting and taking out components specific to discharge contained in the change in circuit current occurring due to disconnection discharge or dielectric breakdown discharge in other than a manner where the detection voltage of the detection terminals 40, 42 are rectified, smoothed out and taken out by the diode 44, capacitor 46 and resistor 48.

e If the inverter controller 20 has no operation stopping means, a switching circuit serving as control means for cancelling the inverter operation may be provided at the DC input of the inverter controller 20 for canceling the supply of power relative to the inverter controller 20 by the detection voltage Vs at the time of behavioral anomaly.

f Although the inverter controller 20 is exemplified as the control means, the supply of power to the inverter controller 20 is controlled using the processor 78 as the control means and the inverter operation may be stopped at the time of behavioral anomaly.

g Although exemplified is the inverter 2 as a prior art which is driven by a constant current or outputs a lower current in problem to be solved by the invention, the anomaly detection circuit of the inverter, the display device or information processing device of the invention are not limited to such an inverter.

h According to the embodiment of the invention, the primary winding 24 of the inverter transformer 22 is formed of a single winding for facilitating the explanation of the invention, a winding for taking out a feedback signal to be fed to each transistor of the push-pull inverter circuit incorporated in the inverter controller 20 is not excluded, and various inverters are included in the anomaly detection circuit of the inverter of the invention.

i The information processing device is configured to include either or both of the anomaly detection circuit and the display device of the inverter.

j With the anomaly detection circuit of the inverter, the current change detector comprises a rectifying part for rectifying a fluctuation voltage obtained by a magnetic flux change, and a smoothing part for smoothing out a rectified voltage obtained by the rectifying part. With such a configuration, it is possible to obtain a detection signal having a level which is in proportional to the circuit current change with high accuracy from a voltage generated in the current detection line, so that detection of the circuit current change caused by the very small discharge can be effected, thereby enhancing the accuracy of detection.

k With the anomaly detection circuit of the inverter, the current change detector is configured to have a rectifying part for rectifying the fluctuation voltage obtained by the magnetic flux change. The rectifier constituting the rectifying part, for example, the diode 44 is formed of a Schottky diode. Since the Schottky diode has short reverse recovery time compared with a high speed diode, the circuit current change due to discharge and a noise component due to discharge are rectified to take out as a DC component so that the change in circuit current due to very small discharge can be detected, thereby enhancing the accuracy of detection to prevent an erroneous operation.

l With the anomaly detection circuit of the inverter, the current change detector is configured to have the filter for extracting change in current due to disconnection discharge, dielectric breakdown discharge, and so forth. With such a configuration, the change in circuit current due to discharge except a transient current change, for example, when power is tuned on, can be detected with accuracy, and an erroneous operation can be prevented.

m With the anomaly detection circuit of the inverter, the current change detector is configured to have discrete elements comprising a part of the circuit wirings 14, 16, 52, 54, 70, 72 and the current detection line 36 which are independent from one another. With such a configuration, the current change detector is installed in the circuit wiring of the inverter 2, for example, in the circuit wirings 14, 16, 52, 54, 70, 72 at an arbitrary spot thereof, so that the inverter, and so forth can be protected from continuation of behavioral anomaly such as discharge and so forth, thereby enhancing reliability.

n With the anomaly detection circuit of the inverter, the current change detection means is characterized in that it is installed in an arbitrary spot of the circuit wiring leading from the DC input to the load on, the DC input side in the circuit wiring, a part on a primary winding and a part on a secondary winding of the inverter transformer 22 provided in the inverter, or on any of the combination of the parts on the DC input side, the primary and the secondary windings. That is, behavioral anomaly such as discharge, and so forth can be detected in the circuit wirings 14, 16, 52, 54, 70, 72 at an arbitrary spot thereof.

o With the anomaly detection circuit of the inverter, it is configured that the display driving part is incorporated in the control means, and the output thereof is fed to the indicator, thereby displaying behavioral anomaly. That is, the anomalous state can be easily grasped by displaying behavioral anomaly of the inverter and the stop of the inverter operation.

p The inverter controller 20, the current change detector 32 and the comparator 34 are configured by an IC, which is single in number. With such a configuration, a reliability of the anomaly detection circuit of the inverter can be enhanced by the IC, which is single in number and also commercial value of a control IC serving as a constituent of the inverter can be improved, and the number of part can be reduced at the same time.

q The anomaly detection circuit is configured to have the core 74 for forming a magnetic path which is common to the circuit wirings 14, 16, 52, 54, 70, 72 and the current detection line 36. That is, if a magnetic path which is common, for example, to the circuit wirings 16, 54, 72 and the current detection line 36 is formed using the core 74, the magnetic flux change Δ φ at the side of the circuit wirings 16, 54, 72 can act efficiently on the current detection line 36 through the core 74. In this case, since the magnetic flux is intensified by magnetic permeability of the core 74 to act on the current detection line 36, the accuracy of detection of the circuit current change can be enhanced, thereby further enhancing a protecting function of the inverter 2 or the load at the time of behavioral anomaly. The magnetic flux change can be intensified by the magnetic permeability of a magnetic material of the core 74 which is a common magnetic path, and hence sensitivity in detection of the change in current can be enhanced.

r The information processing device is configured to use the inverter of the invention as the power supply device or the FL tube lighting device. With such a configuration, a high reliable information processing device can be provided.

s A lighting device provided with the anomaly detection circuit of the inverter is configured. That is, the detection of disconnection discharge and the dielectric breakdown discharge of the inverter, the stop of the operation, and the display accompanied thereby can be effected, thereby providing high reliable lighting device.

Although the best mode for carrying out the invention, the object, the configuration and the operation and effect have been described in detail above, the invention is not limited to such embodiment for carrying out the invention, and it is a matter of course that the invention can be variously changed or modified on the basis of a gist and split of the invention as disclosed in claims and the detailed description of the invention, and such a change or modification, and various conjectured configurations, modified examples and so forth are included in the scope of the invention, and the description of the specification and drawings are not restrictively understood.

The disclosure of Japanese Patent Application No. 2002-212666 including specification, claims, and drawings, is incorporated herein by reference.

What is claimed is:

1. An anomaly detection circuit of an inverter which converts a DC input into an AC output so as to feed the AC output to a load comprising:
a current change detector which detects change in a circuit current flowing in circuit wirings of the inverter leading from the DC input to the load through the intermediary of magnetic flux change occurring to the circuit wiring; and
a detection signal output part which detects that the change in circuit current detected by the current change detector exceeds a predetermined level, thereby outputting a detection signal representing behavioral anomaly.

2. An anomaly detection circuit according to claim 1, further comprising a controller which stops an operation of the inverter when the detection signal outputted from the detection signal output part represents behavioral anomaly.

3. An anomaly detection circuit according to claim 1, wherein the current change detector is installed on any of a part on the DC input side in the circuit wiring, a part on a primary winding and a part on a secondary winding of an inverter transformer provided in the inverter, or on any of the combination of the parts on the DC input side, the primary and the secondary windings.

4. An anomaly detection circuit according to claim 1, wherein the current change detector has a detection line arranged in the vicinity of the circuit wiring, and said detection line detects the magnetic flux change occurring to the circuit wiring, and converts the magnetic flux change into a voltage and takes out the converted voltage.

5. An anomaly detection circuit according to claim 1, wherein the current change detector has a filter which extracts the change in current caused by disconnection discharge or dielectric breakdown discharge in the circuit wiring.

6. An anomaly detection circuit according to claim 3, wherein the current change detector has a rectifying part which rectifies a voltage and a smoothing part which smoothes out an output voltage of the rectifying part and takes out the smoothed output voltage.

7. An anomaly detection circuit according to claim 3, wherein the detection line and a part of the circuit wiring constitute a discrete element.

8. An anomaly detection circuit according to claim 3, further comprising a core provided between the circuit wiring and the detection line which forms a common magnetic path.

9. An anomaly detection circuit according to claim 3, wherein the detection signal output part and a controller are formed of an IC, which is single in number.

10. An anomaly detection circuit according to claim 6, wherein the rectifier constituting the rectifying part is a Schottky diode.

11. An electronic apparatus including an inverter comprising:
an anomaly detection circuit which detects anomaly caused by disconnection discharge in a circuit wiring of the inverter or proximity discharge between high and low voltage parts of the circuit wiring; and
a controller which stops an operation of the inverter when the anomaly detection circuit detects anomaly.

12. An electronic apparatus including an inverter according to claim 11, further comprising:
a display driving part which generates a display driving output representing the anomaly when the anomaly detection circuit detects anomaly; and
an indicator which displays behavioral anomaly by the display driving output generated in the display driving part.

13. A display device including an inverter comprising:
an anomaly detection circuit which detects anomaly caused by disconnection discharge of a circuit wiring of the inverter or proximity discharge between high and low voltage parts of the circuit wiring; and
a controller which stops an operation of the inverter when the anomaly detection circuit detects anomaly.

14. An information processing device including a display device, said display device comprising:
a fluorescent light tube lighting device including an inverter;
an anomaly detection circuit which detects anomaly caused by disconnection discharge of a circuit wiring of the inverter or proximity discharge between high and low voltage parts of the circuit wiring; and
a controller which stops an operation of the inverter when the anomaly detection circuit detects anomaly.

15. A lighting device including an inverter comprising:
an anomaly detection circuit which detects anomaly caused by disconnection discharge of a circuit wiring of the inverter or proximity discharge between high and low voltage parts of the circuit wiring; and
a controller which stops an operation of the inverter when the anomaly detection circuit detects anomaly.
